(19) United States
(12) Patent Application Publication
(10) Pub. No.: US 2021/0217380 A1
(43) Pub. Date: Jul. 15, 2021

(54) VEHICLE STRUCTURE FOR DISPLAY

(71) Applicant: HONDA MOTOR CO., LTD., Tokyo (JP)

(72) Inventors: Tomoyuki Kato, Saitama (JP); Hiroshi Yoshida, Saitama (JP)

(73) Assignee: HONDA MOTOR CO., LTD., Tokyo (JP)

(21) Appl. No.: 16/742,291

(22) Filed: Jan. 14, 2020

(51) Int. Cl. G09G 5/10; G06F 3/14

(52) U.S. Cl. CPC G09G 5/10; G09G 2380/10; G09G 2354/00; G06F 3/1423

(57) ABSTRACT

A first display unit and a second display unit are arranged at an upper part of a side surface of a vehicle body so as to be separated from each other in a longitudinal direction of an opening. The first display unit and second display unit each include a first luminous display surface and a second luminous display surface on a pedestal. Meanwhile, a first corner of a first transparent part and a second corner of a second transparent part are arranged in the first sliding door and second sliding door at parts thereof to cross over the first display unit and second display unit, respectively, when the opening is open.

### BACKGROUND OF THE INVENTION

### Field of the Invention

The present invention relates to a vehicle structure for display.

### Description of the Related Art

For example, there is a conventional vehicle structure for display used for a vehicle dispatch system to dispatch a vehicle to a user (see Japanese Application Publication No. H4-27220).

In the system as described above, when a dispatch center of the dispatch system receives a dispatch request from the user, the dispatch center allocates dispatch data to a vehicle among a plurality of vehicles, which meets conditions. The dispatch data sent from the dispatch center is received by a corresponding vehicle.

Each vehicle includes a display unit arranged near a windshield or a rear glass, to display a vehicle identification mark such as a dispatch number.

The user sees the vehicle identification mark displayed on the display unit to confirm that the dispatch number displayed matches the dispatch number for the user's request before riding on the vehicle.

The vehicle identification mark displayed on the display unit is desirably visible to the user when the user rides on the vehicle through a door opening.

However, if the display unit is arranged on a side surface of a vehicle body with the door opening, the display unit may be hidden by an opened door.

Further, if the display unit is arranged on the door to be opened/closed, there is a problem that the display unit is hard to be seen due to changes in position and angle thereof with the opening/closing movement of the door.

For example, unspecified users ride on the same vehicle for ride sharing or the like. In such a case, the user has to instantly read the vehicle identification mark to determine whether the vehicle is the one for the user, even if the display unit is hard to be seen while the door is in the middle of being opened. Therefore, there is a room for further improvement.

The present invention is intended to provide a vehicle structure for display which provides good visibility of a vehicle identification mark displayed on a display unit, regardless a state of a door in terms of being opened or closed.

### SUMMARY OF THE INVENTION

An aspect of the present invention is to provide a vehicle structure for display including: an opening/closing body arranged in an opening of a vehicle body and sliding along the vehicle body; and a display unit arranged on the vehicle body and displaying a vehicle identification mark so as to be seen from outside of the vehicle, wherein the opening/closing body includes a transparent part having transparency at a part to cross over the display unit when the opening is open.

### BRIEF DESCRIPTION OF THE DRAWINGS

FIG. 1 is a perspective view of a vehicle structure for display of a first embodiment of the present invention, when sliding doors are closed;

FIG. 2 is a perspective view of the vehicle structure for display of the first embodiment of the present invention, when the sliding doors are opened;

FIG. 3 is a schematic plan view of the vehicle structure for display of the first embodiment of the present invention, illustrating an entire configuration of the vehicle; and

FIG. 4 is a side view of the vehicle structure for display of a second embodiment of the present invention, showing main parts when the sliding door is in the middle of being opened.

### DETAILED DESCRIPTION OF THE PREFERRED EMBODIMENTS

A description will be given of a first embodiment of the present invention, with reference to the drawings as appropriate. The same components are denoted by the same reference numerals and duplicate descriptions are omitted. When a direction is described, the description is basically made based on a longitudinal direction, a lateral direction or a vertical direction as viewed from a driver, unless otherwise specified. Further, the “lateral direction” indicates a “right-left direction”.

### First Embodiment

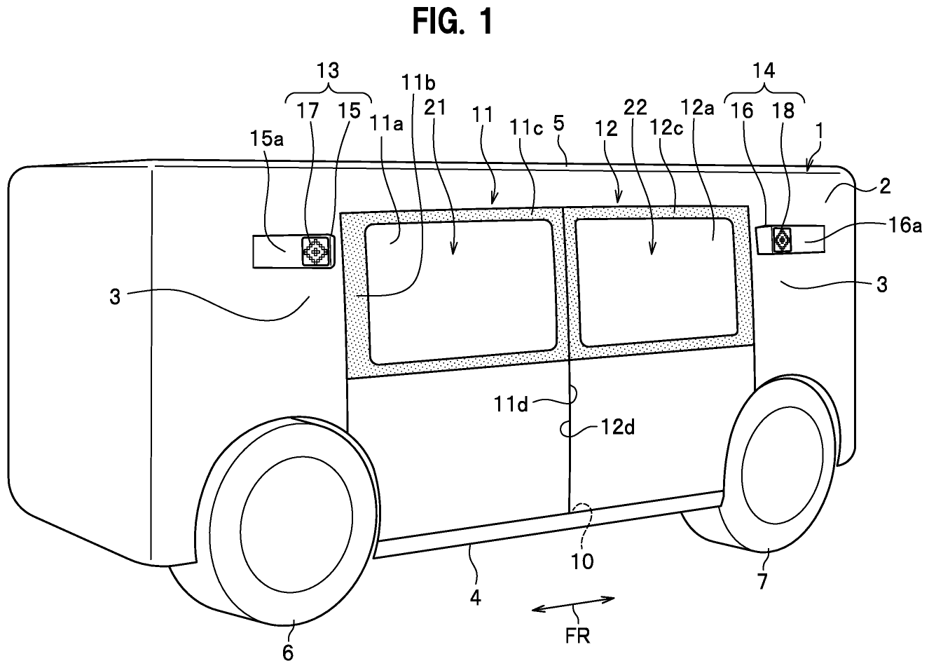

FIG. 1 is a perspective view of a vehicle 1 applied with a basic vehicle structure for display of a first embodiment of the present invention.

The vehicle 1 of the present embodiment 1 mainly includes a vehicle body 2, front wheels 6, and rear wheels 7. The vehicle body 2 includes a drive source (not shown). A drive force of the drive source drives the front wheels 6 or rear wheels 7 for rotation to allow the vehicle 1 to travel in a longitudinal direction FR of the vehicle.

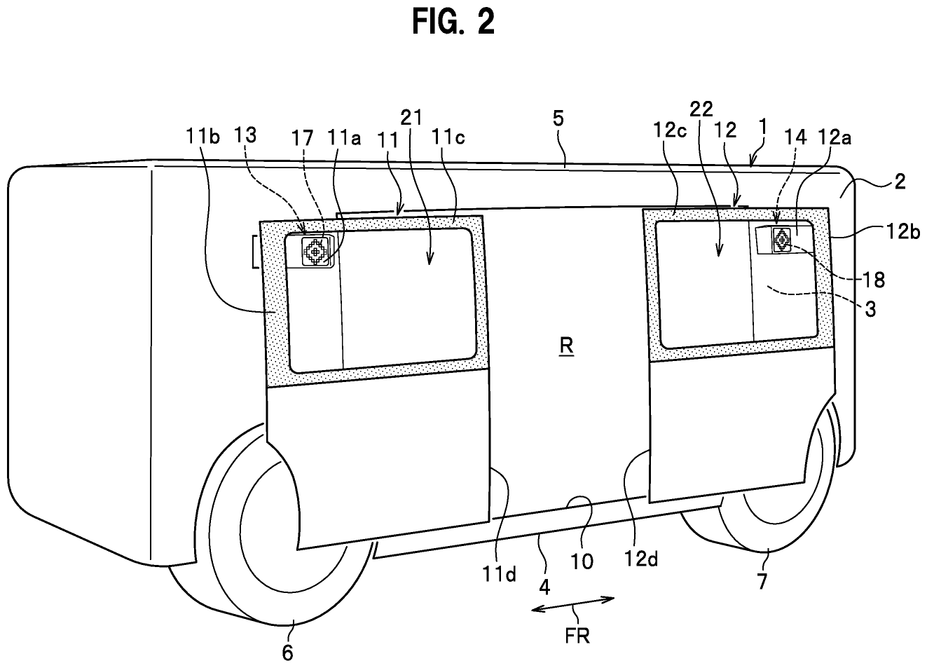

The vehicle body 2 is elongated in the longitudinal direction of the vehicle and is substantially formed in a hollow box shape. A compartment R is defined in the vehicle body 2 (see FIG. 2).

Further, an opening 10 for passengers stepping on and stepping off is defined on a side surface 3 of the vehicle body 2.

The opening 10 is open between a floor 4 and a ceiling 5 of the vehicle body 2 in the vertical direction, and between the front wheel 6 and rear wheel 7 in the longitudinal direction, across an entire area thereof.

Thus, the opening 10 is defined to have the upper side longer than the lower side, to have a substantially trapezoidal shape in side view. When being in an open state, the opening 10 allows the compartment R to communicate with outside.

Further, a first display unit 13 and a second display unit 14 are arranged on an upper part of the side surface 3 of the vehicle body 2. The first display unit 13 and second display unit 14 are arranged on the periphery of the opening 10, at positions above respective front and rear tire wheel housings and farthest from each other in the longitudinal direction of the vehicle around.

Further, the opening 10 includes a first sliding door 11, as a first opening/closing body, arranged on a front side surface of the vehicle body 2 and a second sliding door 12, as a second opening/closing body, arranged on a rear side surface of the vehicle body 2.

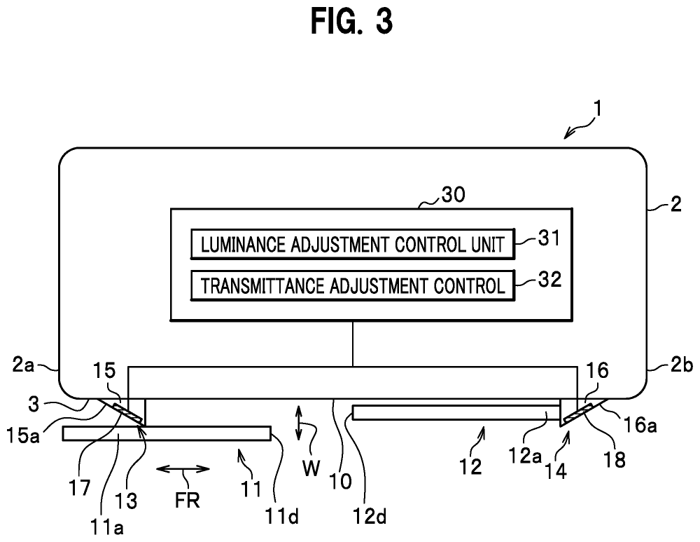

As shown in FIG. 3, the first sliding door 11 and second sliding door 12 respectively slide along the side surface of the vehicle body 2 in the longitudinal direction FR of the vehicle.

In this instance, the first sliding door 11 and second sliding door 12 of the first embodiment protrude outward by a predetermined distance in the lateral direction W. Therefore, the first sliding door 11 crosses over the first display unit 13 in the lateral direction W, without interfering therewith.

Further, the second sliding door 12 crosses over the second display unit 14 in the lateral direction W, without interfering therewith.

Accordingly, a distance between side edges 11d and 12d, facing to each other, is widened with the first sliding door 11 and second sliding door 12 being opened, as shown in FIG. 2. Thus, the opening 10 of the vehicle 1 is widely open in the longitudinal direction of the vehicle.

Further, as shown in FIG. 3, when the side edges 11d and 12d are abutted for closing the doors, the first sliding door 11 and second sliding door 12 are moved inward in the lateral direction W.

Therefore, the opening 10 can be securely closed by the first sliding door 11 and second sliding door 12 with outer peripheries thereof being in contact with the periphery of the opening 10.

Further, the first display unit 13 and second display unit 14 include, at upper parts of the side surface 3, pedestals 15, 16 having respective casings arranged above the front wheel 6 and rear wheel 7, and a first luminous display surface 17 and a second luminous display surface 18, respectively.

Among these components, each casing of the pedestals 15, 16 has a substantially triangular shape in top view and has an inclined surface 15a or 16a on the outer side. The inclined surfaces 15a, 16a are inclined so as to be further away from the side surface 3 with an increasing distance from a front end 2a or a rear end 2b of the vehicle body 2 toward the center of the vehicle.

The first luminous display surface 17 is mounted on the inclined surface 15a, and the second luminous display surface 18 is mounted on the inclined surface 16a, respectively. The first luminous display surface 17 and second luminous display surface 18 include a plurality of LEDs in display surfaces thereof.

Thus, the first luminous display surface 17 and second luminous display surface 18 are fixed to the vehicle body 2 at an angle, so that the optical axis directions of the LEDs can be inclined with respect to the longitudinal direction of the vehicle.

In the first embodiment, an inclined angle of the first luminous display surface 17 and second luminous display surface 18 is set between about 15 degrees to 75 degrees, and preferably, between about 30 degrees to 60 degrees.

The first display unit 13 and second display unit 14 are respectively connected to a controller 30.

The controller 30 includes a luminance adjustment control unit 31 to adjust luminance of luminous display and a transmittance adjustment control unit 32 to adjust transmittance of a transparent part.

When the controller 30 receives dispatch data, the LEDs of the first display unit 13 and second display unit 14 are turned on through electrical conduction, to display the vehicle identification mark so as to be seen from outside of the vehicle.

The vehicle identification mark includes a dispatch number, characters, marks, and a combination of messages or colors (referred to as dispatch number or the like) to allow the user to recognize the dispatched vehicle.

The luminance adjustment control unit 31 controls a voltage to turn on the LEDs for changing a luminance amount.

For example, during a daytime where the outside of the vehicle is bright, the luminous amount is increased. In contrast, during a nighttime where the outside of the vehicle is dark, the luminous amount is decreased.

Further, control of adjusting the luminous amount based on brightness in the compartment R may be further or independently added. For example, when the compartment R is bright, the luminous amount is increased, and when the compartment R is dark, the luminous amount is decreased.

A first corner 11a and a second corner 12a, which are transparent, are formed in the first sliding door 11 and second sliding door 12 of the first embodiment, at parts thereof to cross over the first display unit 13 and second display unit 14, respectively, when the opening 10 is open.

Specifically, as shown in FIG. 1, a first transparent part 21 and a second transparent part 22, which are transparent and serve as windows, are arranged in the first sliding door 11 and second sliding door 12, respectively.

A first colored part lib and a second colored part 12b printed in black are formed in a rectangular ring shape around the first transparent part 21 and second transparent part 22, respectively. The first colored part lib and second colored part 12b hide sealers and connection portions between members and partly shield sunlight.

Further, the first transparent part 21 of the first embodiment includes the first corner 11a, alongside the upper side, at a front end thereof, and the second transparent part 22 includes the second corner 12, alongside the upper side, at a rear end thereof.

Thus, the first transparent part 21 and second transparent part 22 includes the first corner 11a and second corner 12a so as to be integral therewith at inner sides of corners on the upper side in side view.

The first corner 11a and second corner 12a are formed to cross over the first display unit 13 and second display unit 14, respectively, in the lateral direction W, when the first sliding door 11 and second sliding door 12 are opened.

Further, a liquid crystal shutter is arranged to change the transmittance in the first corner 11a of the first embodiment. The liquid crystal shutter changes the transmittance of the first corner 11a based on drive control by the transmittance adjustment control unit 32.

The transmittance adjustment control unit 32 of the controller 30 controls driving the liquid crystal shutter arranged in the first corner 11a so as to adjust the first corner 11a to have desired transmittance.

For example, when the first sliding door 11 and second sliding door 12 are opened, the transmittance of the first corner 11a and second corner 12a is increased so that the vehicle identification mark is visible.

Further, during a daytime where the outside of the vehicle is light, the transmittance is decreased, and contrast is increased, and, during a nighttime where the outside of the vehicle is dark, the transmittance is increased so that the vehicle identification mark is visible even when display luminance thereof is low.

Further, control of adjusting the transmittance based on brightness in the compartment R may be further or independently added. For example, when the compartment R is bright, the transmittance is decreased to increase contrast, and, when the compartment R is dark, the transmittance is increased so that the vehicle identification mark is visible even when the display luminance thereof is low.

Next, a description will be given of advantageous effects of the vehicle structure for display of the first embodiment.

With the vehicle structure for display of the first embodiment, the visibility of the vehicle identification mark displayed on the first display unit 13 or second display unit 14 is satisfactory, regardless of a state of the first sliding door 11 and second sliding door 12 in terms of being opened or closed.

In particular, as shown in FIG. 1, when the first sliding door 11 and second sliding door 12 are closed, the first sliding door 11 and second sliding door 12 are not present over the first display unit 13 or second display unit 14.

Therefore, the vehicle identification mark displayed on the first display unit 13 or second display unit 14 is visible from outside easily.

Further, as shown in FIG. 2, when the first sliding door 11 and second sliding door 12 are opened, the first corner 11a and second corner 12a cross over the first display unit 13 or the second display unit 14 in the lateral direction W.

Therefore, the vehicle identification mark displayed on the first display unit 13 or second display unit 14 is visible from outside of the vehicle 1 easily through the first corner 11a or second corner 12a.

The user sees the dispatch number displayed on the first luminance display surface 17 or second luminance display surface 18 to confirm that the dispatch number matches the dispatch number for the user's request. Then, the user can ride on or pass on the vehicle 1.

For example, unspecified users ride on the same vehicle 1 or the like for ride sharing. In such a case, there may be a case where the first sliding door 11 and second sliding door 12 are being kept open for users who firstly ride on.

With the vehicle structure for display of the first embodiment, the user can instantly read the vehicle identification mark to determine whether the vehicle 1 is the right one, even when the opening 10 is open (also referred to as an open time) with the first sliding door 11 and second sliding door 12 having been slid. This improves convenience.

Further, the first transparent part 21 of the first sliding door 11 is formed with the first corner 11a at a part thereof, extending toward the front of the vehicle along the upper side so as to be integral therewith. Still further, the second transparent part 22 of the second sliding door 12 is formed with the second corner 12a, at a part thereof, extending toward the rear of the vehicle along the upper side, so as to be integral therewith.

Therefore, separate members from the first transparent part 21 and second transparent part 22 are not required to form the first corner 11a and second corner 12a.

Further, as shown in FIG. 3, in the controller 30 provided in the vehicle 1, the luminance adjustment control unit 31 causes the vehicle identification mark to be displayed as electric luminous display and adjusts the luminance of the luminous display.

That is, depending on weather or time, brightness around the first display unit 13 and second display unit 14 may change inside the first sliding door 11 or second sliding door 12.

Even in such a case, the luminance adjustment control unit 31 adjusts the luminance of the vehicle identification mark in consideration of the brightness inside the compartment R. Thus, the brightness can be set to have user-friendly brightness easily so that the visibility is further improved.

Further, as shown in FIG. 3, in the controller 30 provided in the vehicle 1, the transmittance adjustment control unit 32 controls the liquid crystal shutter arranged in the first corner 11a or the second corner 12a, to adjust the transmittance of the first corner 11a or the second corner 12a.

That is, the brightness inside the first sliding door 11 or second sliding door 12 may change depending on weather or time.

Even in such a case, the transmittance adjustment control unit 32 can adjust the transmittance of the liquid crystal shutter in the first corner 11a or second corner 12a to have user-friendly transmittance. Therefore, the visibility is further improved.

Further, as shown in FIG. 3, the first display unit 13 and the second display unit 14 provided on the vehicle 1 include the first luminous display surface 17 and second luminous display surface 18 on the inclined surfaces 15a and 16a respectively arranged on the outer side of the substantially triangular casings in top view.

The inclined surfaces 15a and 16a are formed at an angle so as to be further away from the side surface 3 with an increasing distance from the front end 2a or the rear end 2b of the vehicle body 2 toward the center of the vehicle.

Thus, the first luminous display surface 17 and second luminous display surface 18 are arranged in the longitudinal direction at an angle to the side surface 3 of the vehicle body 2.

Therefore, even when the first display unit 13 or second display unit 14 is arranged on the side surface 3, the user positioned anterior or posterior to the vehicle 1 can easily recognize the vehicle identification mark displayed on the first luminous display surface 17 or second luminous display surface 18.

In the vehicle structure for display of the vehicle 1 according to the first embodiment, as shown in FIG. 3, the first display unit 13 including the first luminous display surface 17 and the second display unit 14 including the second luminous display surface 18 are arranged on the side surface 3 at the front and rear of the vehicle 1.

Therefore, the vehicle identification mark displayed on the first luminous display surface 17 or second luminous display surface 18 is visible to the user from various angles including the front and rear directions, in addition to the lateral direction.

Further, as shown in FIG. 3, the first sliding door 11 and second sliding door 12 are moved in the lateral direction W. Thus, even if the first display unit 13 or second display unit 14 protrudes outward in the lateral direction W from the side surface 3, the first sliding door 11 and second sliding door 12 do not interfere with the display units.

Accordingly, the first sliding door 11 and second sliding door 12 are slid simultaneously in the longitudinal direction FR of the vehicle so that the opening 10 is widely open.

Further, as shown in FIG. 2, when the first sliding door 11 and second sliding door 12 are simultaneously opened, the first corner 11a or second corner 12a, which are transparent, cross over, in the lateral direction W, the first luminous display surface 17 of the first display unit 13 or the second luminous surface 18 of the second display unit 14, respectively.

Accordingly, even when the first sliding door 11 and the second sliding door 12 are slid to widely open the opening 10, the vehicle identification mark displayed on the first display unit 13 or second display unit 14 is visible from outside.

Therefore, the visibility of the vehicle identification mark is improved while an opening area of the opening 10 is secured to be wide, to improve convenience.

### Second Embodiment

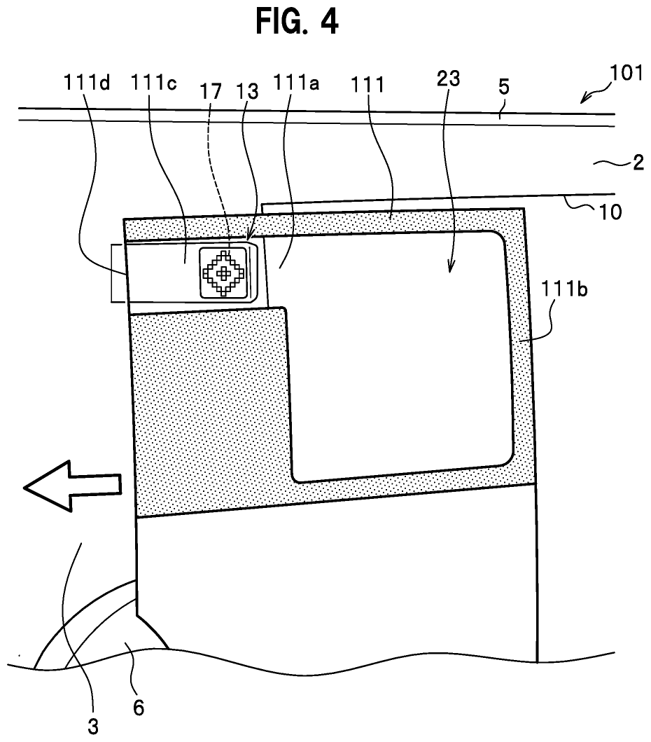

FIG. 4 illustrates a configuration of the vehicle structure for display of a second embodiment of the present invention, to show a configuration of a main part of a third transparent part 23 corresponding to the first transparent part 21 (see FIG. 1) of the first embodiment.

Parts which are the same as, or equivalent to, those in the first embodiment are denoted by the same reference numerals, and descriptions thereof are omitted. That is, the vehicle structure for display at the rear of a vehicle 101 is configured to be the same as that at the front of the vehicle 101 described below. Therefore, descriptions thereof are omitted.

In the vehicle structure for display according to the second embodiment, as shown in FIG. 4, a first sliding door 111 is arranged in the opening 10 of the vehicle body 2. The third transparent part 23, which is transparent, is arranged in the first sliding door 111.

A third colored part 111b is printed in black around the third transparent part 23, and is set to have lower transmittance than the third transparent part 23.

Further, a fourth transparent part 111c is integrally extended from the third transparent part 23. The fourth transparent part 111c of the present embodiment is configured to have a substantially C-shape in side view, in which a front part of a first corner 111a, in the third colored part 111b formed to surround the third transparent part 23, is partially cut off in the longitudinal direction of the vehicle.

Thus, the fourth transparent part 111c is continuous to the first corner 111a in the longitudinal direction of the vehicle. The third transparent part 23 having high transmittance extends to a front end 111d of the door in a convex shape protruding frontward in the longitudinal direction of the vehicle.

Next, a description will be given of advantageous effects of the vehicle structure for display of the second embodiment.

In the vehicle structure for display of the second embodiment, in addition to the advantageous effects of the vehicle structure for display of the first embodiment, the third transparent part 23 having high transmittance is continuously extended to the front end 111d by way of the fourth transparent part 111c positioned at the front in the longitudinal direction of the vehicle of the first corner 111a.

Accordingly, as shown in FIG. 4, even when the first sliding door 111 is in the middle of being opened or closed, the fourth transparent part 111c having transparency crosses over the first display part 13.

Therefore, the first luminous display surface 17 is visible from outside through the fourth transparent part 111c. Therefore, the user does not need to wait until the first sliding door 111 is completely opened.

Further, the third transparent part 23 includes the fourth transparent part 111c having the same transmittance as that of the first corner 111a. Therefore, an appearance of the vehicle identification mark is made substantially the same as that at the time of opening/closing the first sliding door 111 and at the time of being open. Accordingly, the visibility is further improved.

Other configurations and advantageous effects are the same as, or equivalent to, those of the vehicle structure for display of the first embodiment, and descriptions thereof are omitted.

As described above, in the first and second embodiments, the first display unit 13 and second display unit 14 are arranged on the side surface 3 at the front and rear parts thereof, on each of which the vehicle identification mark is displayed to allow the user to visually recognize the vehicle 1 or 101.

The first corner 11a, second corner 12a, or fourth transparent part 111c, crossing over the first display unit 13 and second display unit 14 when the first sliding door 11 or 111 and second sliding door 12 are opened or in the middle of being opened, are formed of a transparent material so as to be integral with the first sliding doors 11, 111, or the second sliding door 12.

Thus, in the vehicles 1 and 101 of the first and second embodiments, the user, who has requested the vehicle dispatch system to dispatch a vehicle, visually recognizes a dispatch number (vehicle identification mark) displayed on the first display unit 13 and the second display unit 14 of the vehicle 1. After confirming that the dispatch number displayed matches the dispatch number for the user's request, the user rides on the vehicle.

At this time, even when the first sliding door 11 and the second sliding door 12 are opened (see FIG. 2) or are in the middle of being opened (see FIG. 4), the dispatch number displayed on the first luminous display surface 17 or second luminous display surface 18 through the first corner 11a, second corner 12a, or the fourth transparent part 111c is easily visible to the user outside the vehicle 1.

For example, even when the first sliding door 11 and the second sliding door 12 remain open for the user who rides on or off first in ride sharing, the user outside can confirm that the dispatch number for the user's request matches the dispatch number displayed.

Therefore, the present embodiment achieves practically useful advantageous effects such that the user can get into the compartment R through the opening 10 being widely open through the sliding movement of the first sliding door 11 and second sliding door 12.

The present invention is not limited to the embodiments described above, and can be modified variously. The embodiments described above are exemplarily described for illustration of the present invention, and are not necessarily limited to those having all the configurations described above. Further, a part of the configuration of one embodiment may be replaced with the configuration of another embodiment, and the configuration of one embodiment may be added to the configuration of another embodiment. Still further, a part of the configuration of each embodiment may be deleted, or may be added or replaced with another configuration. Possible modifications of the above-described embodiments are as follows, for example.

In the first embodiment, the first sliding door 11 and second sliding door 12 are used as opening/closing bodies, but the present invention is not particularly limited thereto. For example, at least one of the first sliding door 11 and second sliding door 12 may be used. The opening/closing body is not limited in shape, quantity, and material, as long as it is arranged in the opening 10 and slides along the vehicle body 2, and may be arranged on at least one of the left, right, front, and rear surfaces.

Further, one of the first sliding door 11 and second sliding door 12 may be slid first in the lateral direction W and the longitudinal direction FR of the vehicle so as to have different opening/closing timings.

Still further, in the first embodiment, the first luminous display surface 17 and second luminous display surface 18 are mounted on the first display unit 13 and the second display unit 14 as display units, respectively, each having a plurality of LEDs.

However, the present invention is not particularly limited thereto. For example, a display surface may be formed with a planar display device such as a liquid crystal panel or an organic EL. That is, the display device is not limited in shape, quantity, and display method, as long as it is arranged on the vehicle body 2 and displays the vehicle identification mark so as to be visible from outside of the vehicle.

Further, in the first embodiment, the first transparent part 21 of the first sliding door 11 has the first corner 11a extending forward in the longitudinal direction of the vehicle along the upper side. However, the present invention is not particularly limited thereto, and the transparent part having transparency may be formed separately from the window.

That is, the transparent part is not particularly limited in shape, quantity, and material, as long as it has a part, having transparency, crossing over the display unit.

Still further, in the first and second embodiments, the first luminous display surface 17 and second luminous display surface 18 are inclined with respect to the side surface 3, but the present invention is not limited thereto. For example, the first luminous display surface 17 and second luminous display surface 18 of the first display unit 13 and second display unit 14 may be directly mounted on the side surface 3 so as to face in the lateral direction W.

That is, the first luminous display surface 17 and second luminous display surface 18 may be arranged at any angle on the first display unit 13 and the second display unit 14.

Yet further, in the first embodiment, the liquid crystal shutter is arranged in the first corner 11a. However, the present invention is not particularly limited thereto, and may have a blind or a light shielding member, for example, and may not have the liquid crystal shutter or the like.

Furthermore, any method and device may be used as long as the transmittance of the first corner 11a is changed based on the control by the transmittance adjustment control unit 32. The shape, quantity, material and control method of the device for changing the transmittance provided in the first corner 11a are not particularly limited.

Instead of the first colored part lib and second colored part 12b, which is printed in black, formed in a rectangular shape or in a substantially C-shape around the first transparent part 21 and second transparent part 22, a liquid crystal shutter may be arranged partly or entirely.

For example, liquid crystal shutters may be arranged all around the first transparent part 21 and second transparent part 22. Further, liquid crystal shutters may be arranged on the entire surfaces of the first transparent part 21 and the second transparent part 22.

Further, in the second embodiment, a liquid crystal shutter may be arranged in the fourth transparent part 111c as shown in FIG. 4 to change the transmittance of the fourth transparent part 111c. That is, when the door is closed, the transmittance of the fourth transparent part 111c is reduced by the liquid crystal shutter, to improve appearance quality by way of blindfolding.

Then, the transmittance of the fourth transparent part 111c may be increased when the door is opened or is in the middle of being opened/closed, so that the visibility of the first display unit 13 and second display unit 14 is improved.

1. A vehicle structure for display comprising:
an opening/closing body arranged in an opening of a vehicle body and sliding along the vehicle body;
a display unit arranged on the vehicle body and displaying a vehicle identification mark so as to be seen from outside of the vehicle,
wherein the display unit is arranged on a side surface of the vehicle body at a position which is covered by the opening/closing body when the opening/closing body is opened, and
wherein the opening/closing body includes a transparent part having transparency at a part of the opening/closing body which covers the display unit when the opening/closing body is opened.

2. The vehicle structure for display as claimed in claim 1, wherein the display unit displays a vehicle identification mark as electric luminous display, further comprising a luminance adjustment control unit to adjust luminance of luminous display.

3. The vehicle structure for display as claimed in claim 1, further comprising a transmittance adjustment control unit to adjust transmittance of the transparent part.

4. The vehicle structure for display as claimed in claim 1, wherein the display unit is inclined so as to be further away from the side surface with an increasing distance from a front end or a rear end of the vehicle body toward a center of the vehicle body.

5. The vehicle structure for display as claimed in claim 1,
wherein the display unit includes a first display unit arranged on a front side surface of the vehicle body and a second display unit arranged on a rear side surface of the vehicle body, and
wherein the opening/closing body includes a first sliding door arranged at a front of the vehicle body to cross over the first display unit, and a second sliding door arranged at a rear of the vehicle body to cross over the second display unit.

6. A vehicle structure for display comprising:
an opening/closing body arranged in an opening of a vehicle body and sliding along the vehicle body;
a display unit arranged on the vehicle body and displaying a vehicle identification mark so as to be seen from outside of the vehicle,
wherein the display unit is arranged on a side surface of the vehicle body at a position which is covered by the opening/closing body during opening or closing the opening/closing body, and
wherein the opening/closing body includes a transparent part having transparency at a part of the opening/closing body which covers the display unit during opening or closing the opening/closing body.

7. The vehicle structure for display as claimed in claim 6, wherein the display unit displays a vehicle identification mark as electric luminous display, further comprising a luminance adjustment control unit to adjust luminance of luminous display.

8. The vehicle structure for display as claimed in claim 6, further comprising a transmittance adjustment control unit to adjust transmittance of the transparent part.

9. The vehicle structure for display as claimed in claim 6, wherein the display unit is inclined so as to be further away from the side surface with an increasing distance from a front end or a rear end of the vehicle body to a center of the vehicle body.

10. The vehicle structure for display as claimed in claim 6,
wherein the display unit includes a first display unit arranged on a front side surface of the vehicle body and a second display unit arranged on a rear side surface of the vehicle body, and
wherein the opening/closing body includes a first sliding door arranged at a front of the vehicle body to cross over the first display unit, and a second sliding door arranged at a rear of the vehicle body to cross over the second display unit.
